(19) United States
(12) Patent Application Publication
(10) Pub. No.: US 2025/0342725 A1
(43) Pub. Date: Nov. 6, 2025

(54) Granular Store Activity Tracking using Computer Vision and Radio-Frequency Identification

(71) Applicant: Automaton, Inc., San Diego, CA (US)

(72) Inventors: Debarun Dhar, New York, NY (US); Dario Rethage, Austin, TX (US); Nihal Soans, Atlanta, GA (US); Joe Mueller, San Diego, CA (US); Giridhar Murali, Sunnyvale, CA (US)

(73) Assignee: Automaton, Inc., San Diego, CA (US)

(21) Appl. No.: 19/196,976

(22) Filed: May 2, 2025

Related U.S. Application Data
(60) Provisional application No. 63/641,907, filed on May 2, 2024.
(60) Provisional application No. 63/702,508, filed on Oct. 2, 2024.

(51) Int. Cl. G06V 40/20; G06K 19/07; G06T 7/70

(52) U.S. Cl. CPC G06V 40/20; G06K 19/0723; G06T 7/70; G06T 2207/30196

(57) ABSTRACT

Systems and methods for tracking items in a retail environment using combined computer vision (CV) and radio frequency identification (RFID) techniques are disclosed. In an exemplary embodiment, local camera nodes (LCNs) track a person through a retail environment and detect interactions between the person and an object or fixture in the environment. In response to detecting the interaction, an RFID sensor queries one or more RFID tags disposed in a sub-volume in which the interaction occurred. A system may determine that the person has picked up an object with an RFID tag, and both the person and the object may be tracked through the retail environment, including when the person exits the retail environment. Inventory may be managed and tracked using these combined CV and RFID techniques.

### CROSS-REFERENCE TO RELATED APPLICATIONS

This application claims the priority benefit, under 35 U.S.C. 119 (e), of U.S. Application No. 63/702,508, filed on Oct. 2, 2024, and of U.S. Application No. 63/641,907, filed on May 2, 2024. Each of these applications is incorporated herein by reference in its entirety for all purpose.

### BACKGROUND

Radio Frequency Identification (RFID) technologies have applications in many commercial areas, such as access control, animal tracking, security, and toll collection. A typical RFID system includes a tag (also referred to as a transponder) and a reader (also referred to as an interrogator or sensor). The reader includes an antenna to transmit radio frequency (RF) signals as well as to receive RF signals reflected or emitted by the tag. The tag can also include an antenna and an application-specific integrated circuit (ASIC) or microchip. A unique electronic product code (EPC) can be assigned to the tag to distinguish it from other tags.

An RFID system can use either an active tag or a passive tag. An active tag contains a transmitter to emit RF signals to the reader and a power source (e.g., a battery) to power the transmitter. In contrast, a passive tag does not contain a power source. Instead, it draws power from the reader via current induced in the tag's antenna by signals from the reader. In a passive RFID system, the reader sends a signal using the reader antenna to excite the tag antenna. Once the tag is powered on (excited), the tag sends the stored data back to the reader.

RFID systems may be used in retail environments to track tags and items to which the tags are affixed, e.g., for inventory management purposes. However, these RFID systems by themselves may be limited in accuracy or resolution, and may suffer from drawbacks in power, transmission range, and limits to communication rate imposed by hop duration and timing.

### SUMMARY

The present technology combines RFID and computer vision (CV) tracking of objects, people, and object-person interactions, for example, in a retail environment, such as a store. Systems and methods of the present technology may be used to track some or all people in the retail environment as well as interactions between those people and objects such as picking up, dropping, moving, carrying, etc., objects in the retail environment. This combined tracking has benefits over traditional RFID-only or CV-only object tracking such as improved resolution, reliability, and accuracy, and enables more complex functionality such as automated item checkout, loss prevention, item abandonment, and in-store pickup of online orders.

The present technology may process data from a plurality of systems including an RFID system and a CV system. These systems may detect people in camera data using machine learning (ML) models, track people and estimate their poses, perform pose lifting (e.g., determining a three-dimensional (3D) pose from two-dimensional (2D) data), optimize poses and detect fixture interactions, and recognize certain actions. These systems may further determine and classify tag motion using RFID methodologies including modified best sensor determination, channel estimate and tag location, and spatiotemporal smoothing. The data analyzed and generated by these processes may be combined and further analyzed using stateful attribution, which may further enable stateful store activity recognition.

People may be identified as they walk into a store or other retail environment and tracked as they move throughout the store. Pose estimation allows for interactions between a person and an object to be identified and classified; for example, when a person reaches into a group of items placed on a fixture such as a table, pose estimation may be used to identify which items they interact with, including items that are picked up, dropped, returned, abandoned, placed in a cart, placed in a bag, etc.

A representation of a retail environment (e.g., a 3D CAD model) may be used to locate people and objects within the retail environment. As people and objects move through the environment, their corresponding locations may be mapped and correlated within the representation, which may in turn be used to predict actions, perform inventory management, prevent theft, and build preferences and/or profiles of users.

The present technology can be implemented as a method of tracking objects and people in a retail environment. In this implementation, a camera acquires imagery (e.g., video or a sequence of still images) of a person in the retail environment. A processor, such as in a local camera node, CV hub, or appliance, estimates a pose of the person based on the imagery and determines, based on the imagery and the pose of the person, that the person has inserted a hand into a predefined volume within the retail environment. In response to determining that the person has inserted the hand into the predefined volume, an RFID tag reader transmits a signal to an RFID tag affixed to an object in the predefined volume. The RFID tag reader receives a response from the RFID tag to the signal and determines, based on the response from the RFID tag, that the person moved the object.

Determining that the person has inserted the hand into the predefined volume may include determining a location of a joint keypoint of the pose relative to the predefined volume.

Determining that the person has moved the object may include determining, based on the response from the RFID tag to the signal, a change in a channel estimate representing a communications channel between the RFID tag reader and the RFID tag. In this case, before the person inserts their hand into the predefined volume, the RFID tag reader can measure a baseline channel estimate representing the communications channel between the RFID tag reader and the RFID tag. This baseline channel estimate can be compared to channel estimate when determining the change in the channel estimate.

The CV hub, appliance, and/or another processor can track the person through the retail environment to the predefined volume based on the imagery. It can also determine that the person has picked up the object and the RFID tag based at least in part on the response from the RFID tag. It can also determine that the person has withdrawn the object and the RFID tag from the predefined volume based at least in part on the response from the RFID tag and associate the object with the person. And it can determine that the person has dropped the object and the RFID tag based at least in part on the response from the RFID tag.

An inventive system for tracking objects and people in a retail environment can include a camera, an RFID tag reader, and at least one processor operably coupled to the camera and the RFID tag reader. In operation, the camera acquires imagery of a person in the retail environment. The processor estimates a pose of the person based on the imagery and determines, based on the imagery and the pose of the person, that the person has inserted a hand into a predefined volume within the retail environment. And the RFID tag reader transmits a signal to an RFID tag affixed to an object in the predefined volume in response to the person inserting the hand into the predefined volume and receives a response from the RFID tag to the signal. The processor can determine, based on the response from the RFID tag, that the person moved the object.

Another implementation of the inventive technology is a method of tracking an object located within a predefined volume and an RFID tag affixed to the object. In this implementation, an image sensor detects a person inserting a hand into the predefined volume, for example, by estimating a pose of the person from image data of the person acquired by the image sensor. In response to the image sensor detecting the person inserting the hand into the predefined volume, an RFID tag reader detects a change in a channel estimate representing a communications channel between the RFID tag reader and the RFID tag. For instance, the RFID tag reader can determine a first channel estimate for the communications channel before (e.g, 5, 10, 15, 30, or more seconds before) the person inserts the hand into the predefined volume and a second channel estimate for the communications channel within a predefined period (e.g., 5, 10, 15, 30, or more seconds) of the person inserting the hand into the predefined volume. Comparing the first and second channel estimates. A processor coupled to the RFID tag reader determines that the person has picked up the object based on the change in the channel estimate. The system can associate the object with the person and track the object and the person within the retail environment using the image sensor and the RFID tag reader.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A illustrates a system for tracking activity in a retail environment using radio-frequency identification (RFID) and computer vision (CV) technology.

FIG. 1B illustrates an exemplary image from a local camera node (LCN) showing bounding boxes around people detected by the LCN in a retail environment.

FIGS. 2A and 2B illustrate functions performed by the RFID/CV activity tracking system of FIG. 1A.

FIG. 3 illustrates a store activity recognition process that can be carried out using the system of FIG. 1A.

FIG. 4A illustrates a computer-aided design (CAD) model representing a retail environment.

FIG. 4B illustrates two people who have been detected in the retail environment of FIG. 4A and are modeled as wireframes.

FIG. 4C illustrates portions of the retail environment of FIG. 4A (which includes a plurality of fixtures) segmented into sub-volumes.

FIG. 5A illustrates an RFID sensor, including components that can be enabled or disabled if the sensor is in interrogator mode or listener mode.

FIG. 5B shows an interrogator controller.

FIG. 6 illustrates an exemplary LCN.

### DETAILED DESCRIPTION

### CV/RFID Activity Tracking System

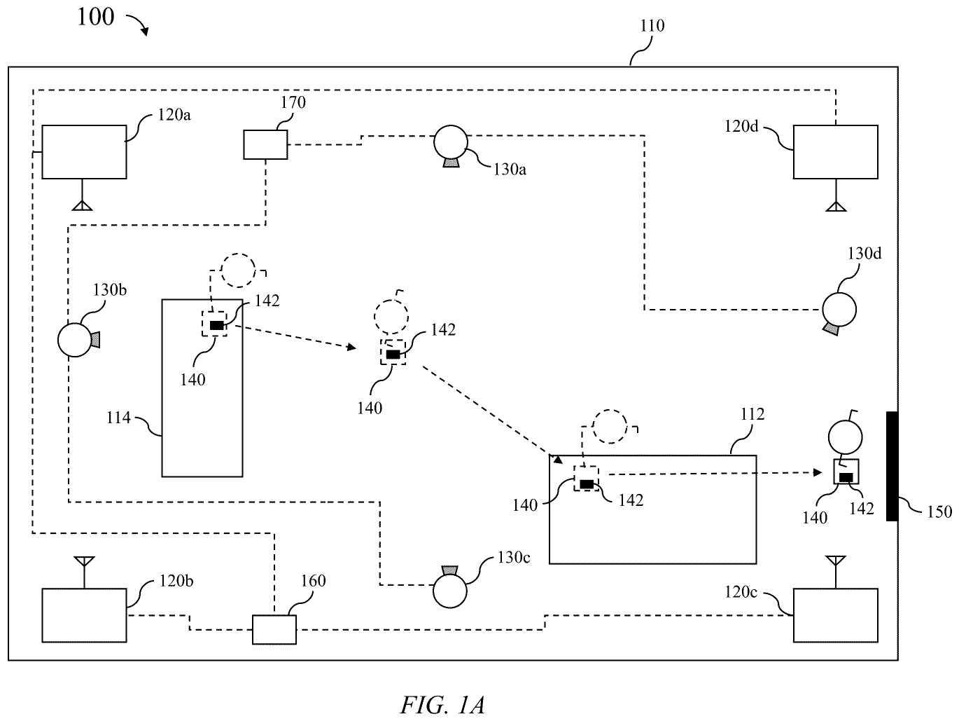

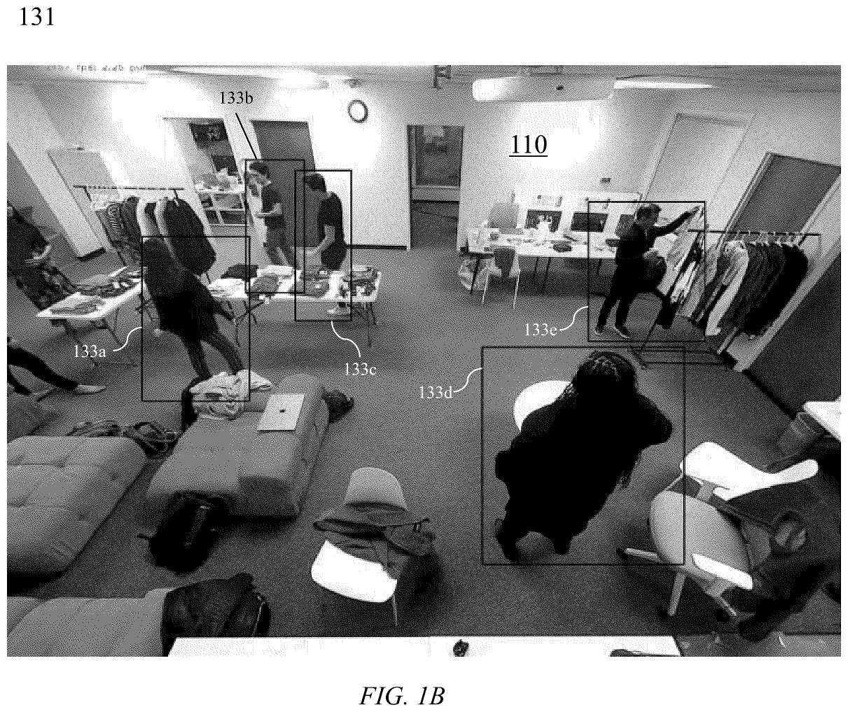

FIG. 1A illustrates a system 100 for tracking activity in a retail environment 110, such as a clothing store, an electronics store, a convenience store, a supermarket, or the like, in accordance with the present technology. System 100 may include RFID sensors 120 (also called interrogators or simply sensors and including sensors 120a-d) operably coupled to an RFID controller 160 (also referred to as an interrogator controller (IC) or appliance) as well as local camera nodes (LCNs) 130 (including LCNs 130a-d) operably coupled to a computer vision (CV) hub 170, which is also operably coupled to the RFID controller 160. (While RFID controller 160 and CV hub 170 are illustrated as separate components, they may be combined into a single component or disposed on adjacent elements of a server, such as adjacent blades.) System 100 uses the RFID sensors 120 to track RFID tags 142 (or simply tags 142) affixed to items 140 for sale and the LCNs 130 to track people and their interactions with the items 140 as described below.

Retail environment 110 may include one or more fixtures such as a checkout area or cashwrap 112 and table 114. These may be structures within the environment that do not move and therefore provide fixed reference points (including known positions and dimensions in 3D space) for evaluating tag and person positions within retail environment 110. The reference points associated with these fixtures may be used to calibrate both the RFID sensors 120 and the LCNs 130 so the data that they collect can be used to more accurately estimate the positions of RFID tags 142, objects, and people in the retail environment 110.

RFID sensors 120 transmit signals to and receive signals from the RFID tag 142 distributed throughout retail environment 110. RFID sensors 120 may each include one or more antenna elements that may be configured to transmit and receive these RFID signals. RFID sensors 120 switch or hop the signals among different frequency channels (carrier frequencies), e.g., within bands of 865-868 MHz (Europe) or 902-928 MHz (North America). RFID sensors 120 detect replies at these frequencies from the RFID tags 142 with their antenna arrays too. They can also use their antenna arrays to steer the transmitted signals and/or the antenna arrays' receptivity patterns to different angles of arrival (AOAs).

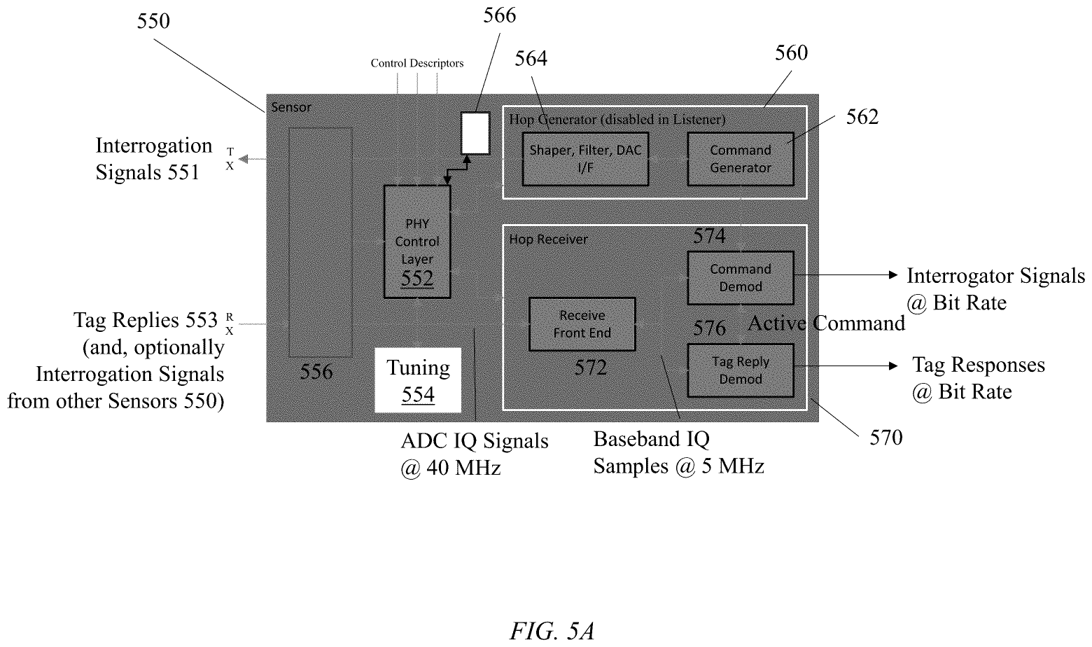

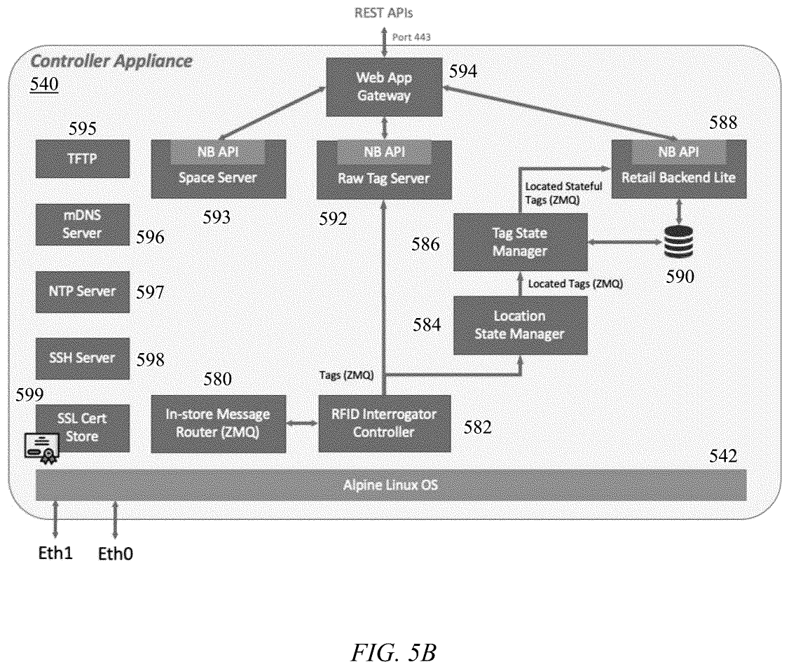

The RFID sensors 120 may be positioned at locations around retail environment 110 to provide suitable signal coverage for tracking RFID tags 142 attached to items 140, such as on a ceiling. If the ceiling is a drop ceiling or secondary ceiling, the RFID sensors 120 can be hung from the ceiling panels, mounted to the ceiling panels, or placed between the ceiling panels and the structural ceiling as disclosed in U.S. Pre-Grant Publication No. 2024/0330619 A1, entitled “Antenna Arrays and Signal Processing for RFID sensors,” which is incorporated herein by reference in its entirety for all purposes. RFID sensors 120 may be positioned such that signals from one or more RFID sensors 120 can reach a given point within retail environment 110 at a suitable signal strength. RFID sensors 120 and their operation are described in greater detail below with respect to FIG. 5A.

RFID sensors 120 may communicate with each other and/or with RFID controller 160 via wireless or wired (e.g., Ethernet) connections. RFID controller 160 may be a specialized computing device or a suitably programmed computer, laptop, or smartphone adapted to communicate with RFID sensors 120 and issue commands recognizable to RFID sensors 120. RFID controller 160 can also receive signals from RFID sensors 120. For example, RFID controller 160 can command RFID sensors 120 to inventory all RFID tags 142 (and attached items) in the retail environment 110 or to determine the location(s) of one or more RFID tags 142 (and attached item(s)) in the retail environment 110. RFID controller 160 can also command RFID sensors 120 to query the RFID tags 142 according to a schedule, e.g., as described in U.S. Pre-Grant Publication No. 2024/0193381 A1, entitled “RFID sensors Switchable between Interrogator and Listener Modes,” which is incorporated herein by reference in its entirety for all purposes. RFID sensors 120 can send raw or processed data representing the RFID tags' replies to RFID controller 160, which uses this data to identify and/or locate the RFID tags 142 and/or attached objects as described below. RFID controller 160 is described in greater detail below with respect to FIG. 5B.

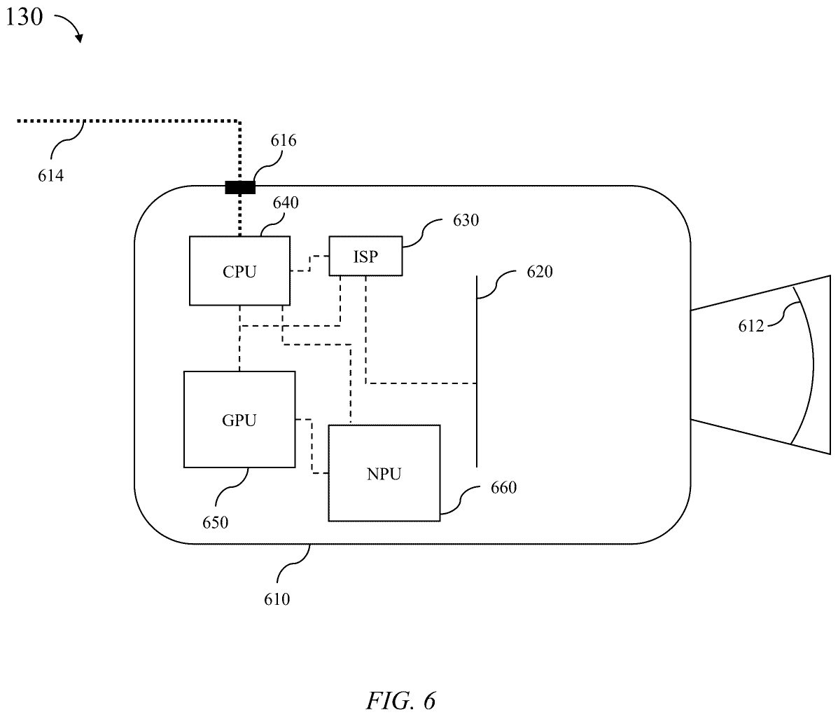

LCNs 130 are also placed throughout retail environment 110 and include cameras to collect image data or visual information about retail environment 110, including visual information that may be used to determine types and positions of objects, people, fixtures, interactions between people and objects, and the like. LCNs 130 may communicate with and receive power from the CV hub 170 using respective power over ethernet (POE) connections to the CV hub 170. LCNs 130 can also be powered by direct connections to a power source such as a wall outlet in retail environment 110, one or more batteries, or any suitable power supply. LCNs 130 and their operation are described in greater detail below with respect to FIG. 6.

The number of LCNs in retail environment 110 may be greater than, equal to, or less than the number of RFID sensors 120 in retail environment 110. The numbers of RFID sensors 120 and LCNs 130 may vary based on a size and/or shape of retail environment 110. In an aspect, RFID sensors 120 and LCNs 130 may have respective effective coverage areas in the retail environment 110; e.g., about 500 sq ft, about 600 sq ft, about 700 sq ft about 800 sq ft, about 900 sq ft, about 1000 sq ft, etc., for each RFID sensor 120 and about 100 sq ft, about 300 sq ft, about 400 sq ft, about 500 sq ft, about 600 sq ft, about 700 sq ft, etc. for each LCN 130. Some portions of retail environment 110 may only be covered by one type of system component; that is, some portions of retail environment 110 may only be covered by one or more RFID sensors 120 and not LCNs 130 (e.g., fitting rooms), while other portions of retail environment 110 may only be covered by LCNs 130 and not RFID sensors 120 (e.g., storage closets).

RFID sensors 120 and LCNs 130 may be time synchronized using a suitable protocol, such as the network time protocol (NTP), in which a clock in each RFID sensor 120 and each LCN 130 is synchronized with an external source through network connections between the RFID sensors 120 and RFID controller 160, and between the LCNs 130 and CV hub 170. RFID controller 160 may additionally or alternatively synchronize LCNs 130 and CV hub 170 may additionally or alternatively synchronize RFID sensors 120.

After installation but prior to operation, each LCN 130 may be calibrated or registered to associate the field of view (FOV) of its camera with a known portion of the retail environment 110, for example, based on a 3D computer-aided design (CAD) model of retail environment 110. One or more permanent or semi-permanent objects within retail environment 110 may be used as reference points for registering the camera FOV to the 3D CAD model. This registration enables CV hub 170 to more accurately determine the positions of objects and/or people imaged by the LCN's camera within retail environment 110. For example, the camera FOV of at least one LCN 130 includes cashwrap 112. The fixed position of cashwrap 112 within retail environment 110 may be known and may accordingly allow the movements and positions of objects and people to be determined relative to the (fixed) position of cashwrap 112. If desired, the CV hub can perform a global registration or calibration based on each LCN's FOV. This global registration or calibration may include identifying fiducial markers placed throughout retail environment 110 and cross-referencing or registering the fiducial markers within FOVs of different LCNs 130. The quality of the global optimization step may be measured in terms of a reprojection error, which may preferably be 1 pixel or less.

Each LCN 130 may include one or more processors that utilize CV techniques, such as the You-Only-Look-Once (YOLO) model, to detect and analyze the movement of people and/or objects within retail environment 110. LCNs 130 may also perform single-shot object detection using a convolutional neural network (CNN) that may predict object classes and object bounding box coordinates simultaneously (an LCN 130 may also use multiple neural network layers to separately classify and bound/locate objects).

FIG. 1B shows an exemplary image 131 from an LCN 130 showing retail environment 110 and bounding boxes 133 (including bounding boxes 133a-e) indicating locations of respective persons detected within the retail environment 110. Each bounding box 133 indicates a detection of a person within a field of view of the LCN 130. Each bounding box 133 is intersected with the floor plane from the 3D CAD model used to register the RFID sensors 120 and/or LCNs 130 or a similar 3D model of retail environment 110. To intersect each bounding box 133 with the floor plane from the 3D CAD model, the CV hub 170 defines the bottom line segment of the bounding box 133 relative to the coordinate system of the LCN 130 that generates the bounding box 133. The coordinate system includes the floor plane of the 3D CAD model, which may then be compared to the bottom line segment of the bounding box 133 to define the location of the bounding box 133 and therefore the location of the detected person.

Each LCN 130 may transmit object identifiers, bounding boxes (e.g., sizes and positions), number of detected objects, and the like, to CV hub 170. (Alternatively, or in addition, each LCN 130 can transmit raw image data to CV hub 170 for processing, including object and person detection.) CV hub 170 may then aggregate and use information from one or more LCNs 130 to track people and objects in three dimensions, detect person-fixture and/or person-object interactions (e.g., a person picking up a t-shirt from a shelf), create probability distributions for the positions of different detected objects (e.g., a person's hand, wrist, or other limb or joint), correlate visually detected positions and movements of RFID-tagged objects with corresponding RFID tag signals, and the like. For example, as each person moves throughout the retail environment 110, the CV hub may combine the bounding boxes 133 for that person from different LCNs, enabling the CV hub 170 to determine the person's 3D location and pose. The LCN 130 or CV hub 170 may track movement and/or changes in dimensions of a bounding box 133 one frame to the next to track the corresponding person's movement through the retail environment. CV hub 170 and/or LCNs 130 may further determine a movement track or trajectory for each detected object over time (e.g., movement of an object from frame to frame) using frame-to-frame tracklets and confidence levels for each bounding box associated with that object.

The LCNs 130 and CV hub 170 track the detected person's 3D position over time as the person moves through retail environment 110 in space and time. If desired, the LCNs 130 and/or CV hub 170 can create a person track for each detected person. The LCNs 130 may stream 3D positions as binary data to CV hub 170 as a detected person moves throughout the retail environment 110, and CV hub 170 may aggregate these 3D positions for each person to create the person track for that person. CV hub 170 may determine a global state for retail environment 110 including a number of people in retail environment 110, positions of people detected in retail environment 110, one or more objects that the detected people have interacted with or are interacting with, a time in store for each detected person, potential items of interest for each detected person, and the like.

As each LCN 130 streams data about detected person(s) to CV hub 170, CV hub 170 processes this data to determine whether a person track should be created, deleted, or associated with an identified person. CV hub 170 may perform nearest neighbor association based on 3D locations of detected persons to match them with existing person tracks. For example, CV hub 170 may calculate a Euclidean distance, a Manhattan distance, or any suitable distance metric to determine an association between a detected person and a person track. CV hub 170 may additionally or alternatively calculate an appearance-based signature for each person track (e.g., based on a shape of a person, a color of clothing or other aspect of the person's appearance, one or more dimensions of the person, etc.) to improve a robustness and/or accuracy of a person track association. An appearance-based signature may be used to reidentify a person when they emerge (or reemerge) from an area not covered by an LCN (such as a fitting room).

CV hub 170 may create a new person track in a predetermined zone, for example, within a predetermined distance of an entrance/exit 150 of retail environment 110. For example, when a person enters retail environment 110 and is detected by one or more of LCNs 130, CV hub 170 may create a person track associated with the person. CV hub 170 may optionally determine one or more conditions for a person track to be considered valid, e.g., that the person track leads a threshold distance into retail environment 110, or that the person track moves away from entrance 150 within a threshold amount of time. If a person is not initially detected within a predetermined distance of an entrance of retail environment 110, the person track may be created wherever the person is initially detected within retail environment 110.

CV hub 170 may delete a person track in response to the person track moving to entrance 150 after a threshold period or duration within retail environment 110. CV hub 170 may delete a person track once the person track is within a threshold distance of entrance 150 and leads outside of retail environment 110 or once the person is no longer detected for a predetermined length of time.

LCNs 130 may be used to detect a movement or adjustment to fixture location. For example, once retail environment 110 is surveyed and a model of retail environment 110 generated, CV hub 170 will have dimensions and positions of each fixture within retail environment 110. These positions for the fixtures may be correlated to image data from each LCN 130 that contains a fixture in its FOV. If a fixture is moved, the corresponding LCN 130 or CV hub 170 may calculate the new position of the fixture by correlating the pixels showing the fixture with the known dimensions of the fixture, as well as the known dimensions and/or coordinates of the environment.

### CV/RFID Activity Tracking System Operation

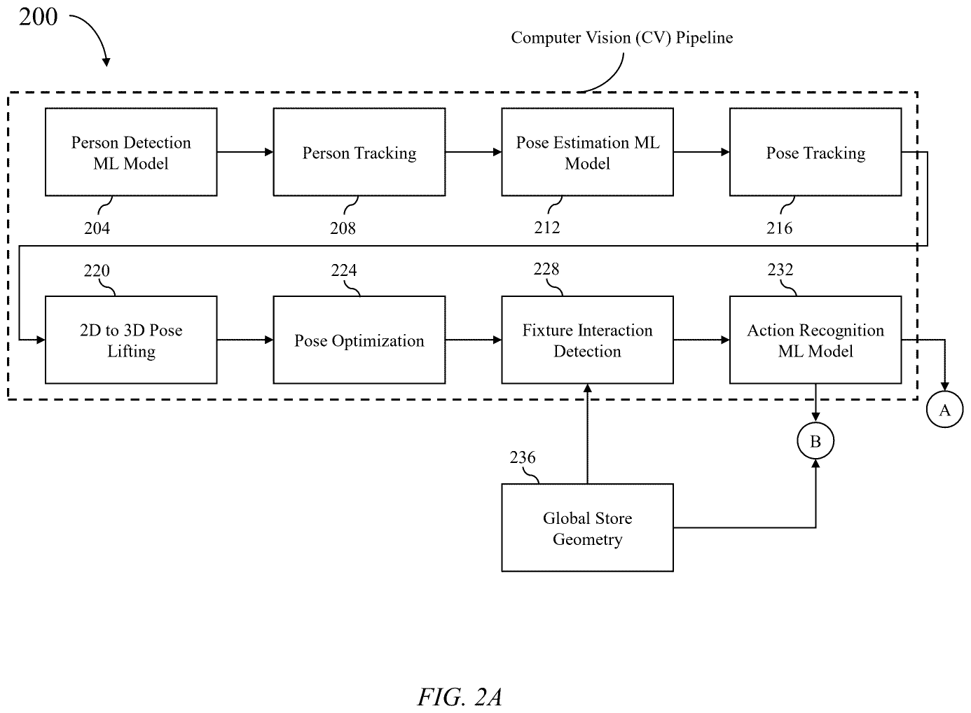

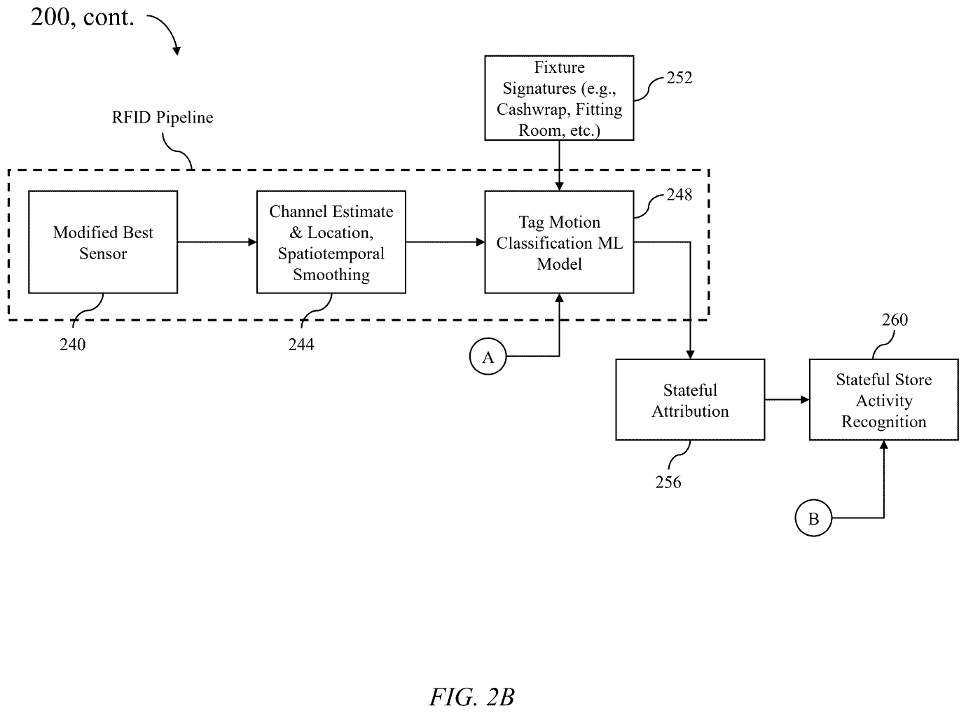

FIGS. 2A and 2B illustrate method 200 that includes blocks or steps performed by an exemplary system, such as system 100 in FIG. 1A, for tracking activity in a retail environment in accordance with the present technology. Method 200 includes a computer vision (CV) pipeline with steps or blocks carried out by the LCNs and/or the CV hub as well as an RFID pipeline with blocks or steps carried out by the RFID sensors and/or the RFID controller.

The CV pipeline in FIG. 2A includes a person detection machine learning (ML) model block 204, which may include processing image data from one or more LCNs and detecting one or more persons in a retail environment from image data of the retail environment. For instance, the LCNs and/or CV hub may detect or sense one or more persons in image data acquired by the LCNs utilizing suitable image processing software, such as the YOLO model.

Persons who are identified using the image data are further tracked using person tracking techniques and/or software (such as ByteTrack) as part of block 208, which may identify a position and/or trajectory for each identified person. One or more LCNs may track a person upon entering a retail environment, for instance, when the person passes through an entrance of the retail environment. If a person is not detected or sensed upon entering a retail environment, a person track may be generated for that person starting at the point in the retail environment at which that person is first detected or sensed.

One or more LCNs may analyze image data showing a person to perform pose estimation for that person, for example, using a suitable ML model. This pose estimation block is illustrated as block 212. The LCN(s) may calculate the person's position and a 2D wireframe including one or more joint keypoints, which represent a person's joints (e.g., a wrist, elbow, finger/hand, shoulder, etc.) and are generated from the image data. This 2D wireframe may be used for pose tracking, illustrated as block 216. Pose tracking block 216 may link individual 2D poses together to generate a motion sequence. This motion sequence may be used to analyze when a person interacts with a particular fixture, object, RFID tag, sub-volume, or the like.

The CV hub may perform 2D to 3D pose lifting, shown as block 220. 2D to 3D pose lifting may include pose reprojection from several LCNs. The CV hub may combine 2D poses from different LCNs into a single 3D pose for a particular person by registering the same features in image data from the LCNs, enabling analysis and tracking of the person's interaction with a retail environment (including with fixtures and objects) over time. These 3D poses may serve as the basis for joint position estimates as described below.

Following the 2D to 3D pose lifting block 220, a pose optimization block 224 reduces or minimizes a reprojection error using a cost minimization function to ensure satisfactory alignment between 2D keypoint detections versus the 2D projections of the 3D joint keypoints. The pose optimization block 224 may start from initial pose estimates and gradually converge on an optimized pose estimate through an iterative reduction of the cost function. Further, block 224 may include suitable heuristics and/or constraints, such as a person should be standing upright, the person is wearing an article of clothing of a certain color, etc. Examples of suitable heuristics/constraints include, but are not limited to: (1) plausible ranges of lengths of limbs (arms); (2) connectivity of key joints (e.g., the upper arm connects the elbow to the shoulder, the forearm connects the wrist to the elbow); and (3) plausible configurations of key joints (e.g., the shoulder is physically separated from the hip).

The CV hub uses these heuristics in pose optimization to refine the lifted 3D person pose/skeleton and transform it to a valid set of coordinates within the store coordinate system. Given a detected person in an image, the CV hub starts with the estimation of their 2D pose in image coordinate space (block 212) as described above. The CV hub lifts a 3D pose of that person in root-relative coordinates (uses the central torso joint of the skeleton as the origin) from the image (block 220). This can be done in multiple steps as described or in one shot in a unified deep learning model.

To use the 3D pose in a store, the CV hub converts from root-relative coordinates to store coordinates. This involves refinement and transformation. Typically, there are multiple possible solutions when going from 2D to 3D. Additionally, there may be some inconsistencies in the estimated pose. Refinement produces a valid 3D solution based on known constraints. Transformation involves rotating, translating and/or scaling the 3D pose so that it can be appropriately placed in a store's 3D coordinate system

The CV hub converts from root-relative coordinates to store coordinates in an optimization step based on 3D-to-2D reprojection error. The heuristics apply constraints to the optimization problem (given that human joints and limbs can only have so many possible configurations). Other heuristics, such as assuming that the person is standing upright, allow for the optimization to converge faster by limiting the search space for valid 3D solutions.

Method 200 may further include a fixture interaction detection block 228, which may include utilizing the optimized 3D pose estimates as well as a global store geometry 236. As described in greater detail below, the fixture interaction detection block 228 may determine when a person has interacted with one or more objects disposed on a fixture or elsewhere in the retail environment by correlating, matching, and/or comparing joint keypoint locations with sub-volume locations associated with the fixture.

Fixture interaction events identified by fixture interaction detection block 228 may be categorized using an action recognition ML model block 232. This action recognition ML model block may include a deep-learned ML model that classifies detected sub-volume interactions into one of several categories, such as reach in, reach out, item pickup, and item drop, as described in greater detail below. Action recognition ML model block 232 may then be used to trigger one or more RFID sensor functions (e.g., querying one or more RFID tags at or near the site of sub-volume interaction), action prediction, person track trajectory prediction, inventory management functions, stop-loss functions, or the like.

The action recognition ML model can be implemented as a deep-learned model that analyzes a short video clip around the timestamp where a fixture interaction occurred and classifies the action into four possible classes: reach in, reach out, pickup item, or drop item, which are described in greater detail below. The action recognition ML model can use the Temporal Shift Module (TSM) for Efficient Video Understanding to recognize pickup and drop item events by sampling frames from a short clip of video data captured by LCN, e.g., a 3-second clip of video, from which six frames are evenly sampled, with three frames (1.5 seconds) before and three frames (1.5 seconds) after a person's wrist enters or exits a sub-volume of a fixture. The TSM is trained on 3-second video clips labeled with one of three classes: [pickup item, drop item, no action]. The training clips are also cropped using the bounding box to only contain the person of interest.

This deep learning method shifts a portion of the feature maps (produced by convolution operations on the input) in the temporal dimension. It uses information from before and after a given frame to make the action classification. This allows the model to learn and leverage temporal information, while remaining very computationally inexpensive. It can be executed in an LCN with a TSM architecture using a MobileNet backbone trained on ImageNet.

FIG. 2B shows the RFID pipeline that is executed by the system and intersects with the LCN pipeline at tag motion classification block 248. The RFID pipeline may include a modified best sensor block 240, which may enable the selection of one or more RFID sensors that make the most accurate estimates of RFID tag locations for RFID tags in or near the interaction sub-volume.

Method 200 may further include a channel estimate and location block as well as spatiotemporal smoothing block, the combined functionality of which is illustrated as block 244. These functionalities provide estimates of RFID tag locations and reduce noise and interference due to obstacles, fixtures, backscattering, and persons obstructing channels. In particular, spatiotemporal smoothing may enable higher accuracy of RFID tag location through improved azimuth and elevation determination. Using channel estimates to detect and locate moving RFID tags is described in greater detail below.

Tag motion classification block 248 may include associating RFID tags with a person in motion (for example, after the person picks up an object with an attached RFID tag), determining inventory status, performing automatic checkout of an item being carried by a person, identifying that an object has been abandoned by a person and should be returned to a particular fixture, or any suitable block associated with an RFID tag in motion. Tag motion classification block 248 may utilize fixture signatures as an input to indicate where an RFID tag may have come from, where an RFID tag may move to, and the like, which may be provided by block 252. Tag motion classification block 248 may further utilize action recognition ML model block 232 as an input.

A stateful attribution block 256 may include trajectory matching between a moving RFID tag and a person's trajectory, for example, using a Frechet distance, which is a measure of similarity between two curves. For example, at each time point in a series of time points, the RFID controller and/or CV hub may determine and compare curves representing the trajectories of a person and an RFID tag using the Frechet distance. In this context, the Frechet distance represents the shortest cord-length sufficient to join a point traveling forward along the person's trajectory and a point traveling forward along the RFID tag's trajectory, although the rate of travel for either point may not necessarily be uniform.

Stateful attribution block 256 may further associate an RFID tag with a person or fixture based on the RFID tag transitioning from stationary to moving or vice versa, for example, when a person drops an object having an attached RFID tag. Stateful attribution block 256 may enable or cause the dropped RFID tag to be associated with a fixture on which the RFID tag is dropped, which may then be used for inventory management or similar tasks.

Action recognition ML model block 232, global store geometry 236, and stateful attribution block 256 may be used for stateful store activity recognition block 260. This block may provide an overall status of a retail environment including a number of objects within a retail environment; a number of persons in the retail environment and their associated positions, trajectories, and carried objects (e.g., retail items having attached RFID tags); fixture location; where objects have been picked up and dropped; potential store hotspots (e.g., locations of particular interest); and the like. For more on stateful recognition, please see U.S. Pre-Grant Publication No. 2024-0386375 A1, entitled “Stateful Inventory for Monitoring RFID Tags,” which is incorporated herein by reference in its entirety for all purposes.

### Store Activity Recognition

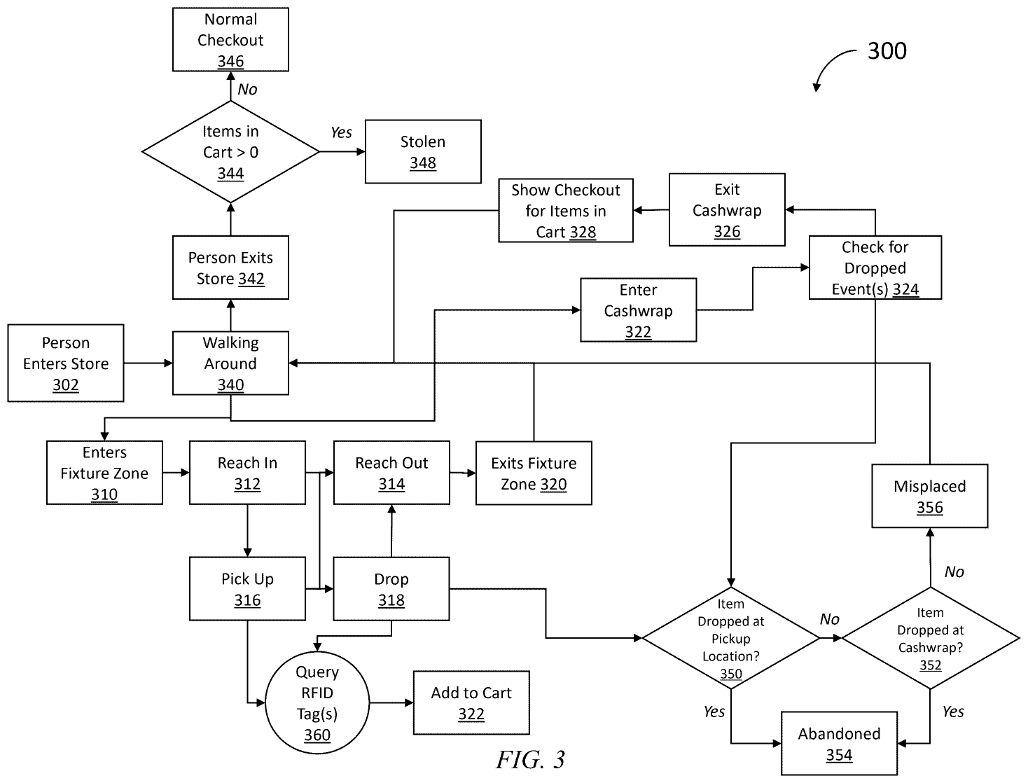

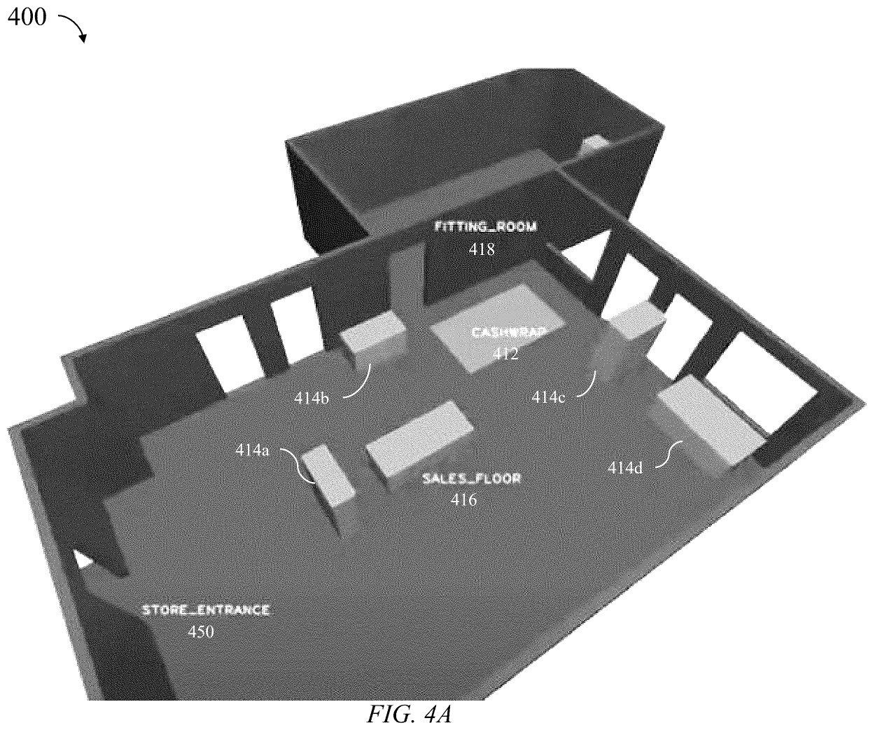

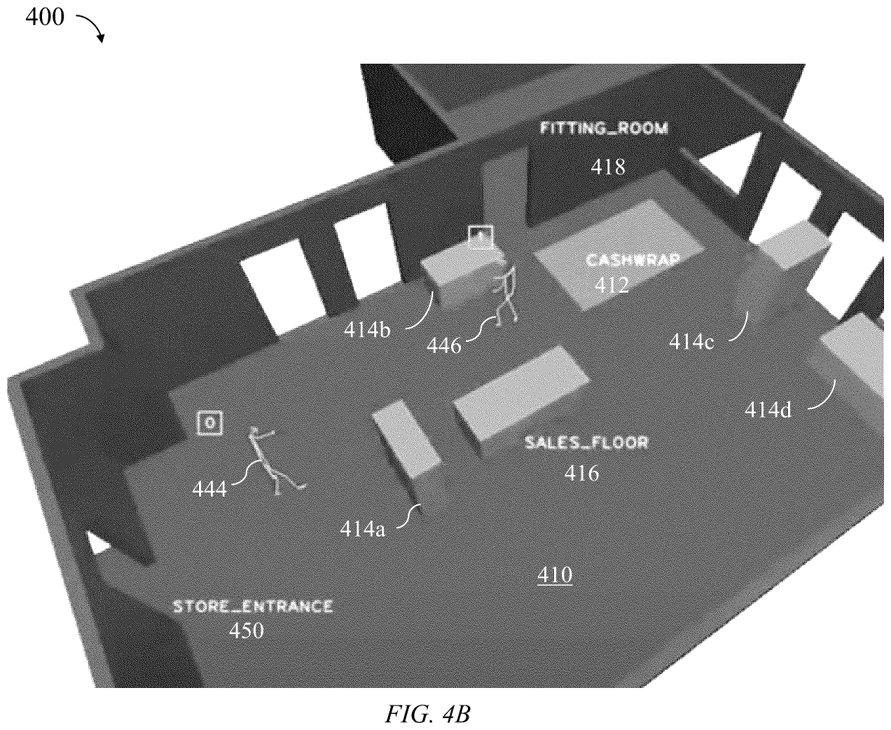

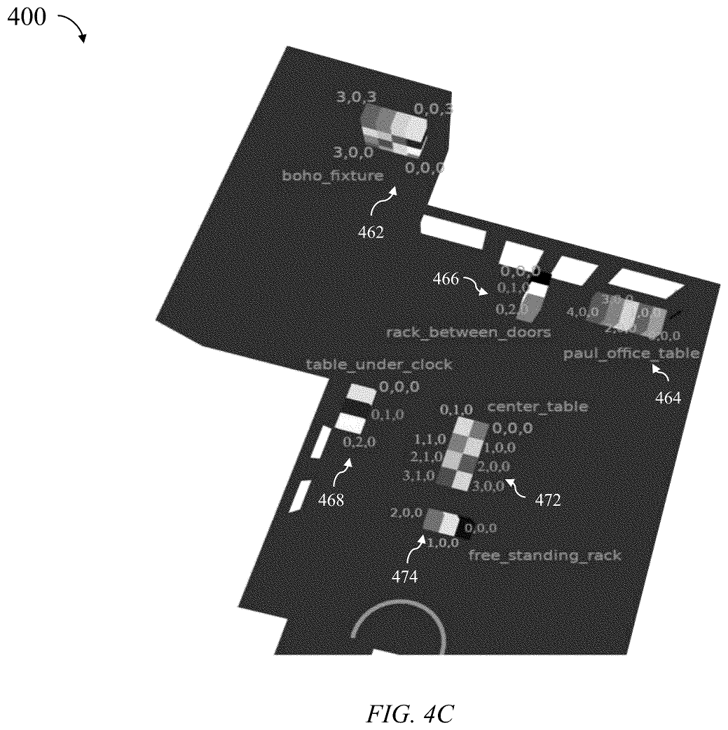

FIGS. 3 and 4A-4C illustrate a process 300 for recognizing activity in a retail environment 410, such as a store, with the system 100 illustrated in FIG. 1A using the CV and RFID pipelines illustrated in FIGS. 2A and 2B. The system uses a CAD model 400, shown in FIG. 4A, to represent the global geometry of the retail environment 410, or global store geometry (GSG). CAD model 400 may include the dimensions of retail environment 410 as well as any fixtures or elements such as cashwrap 412, shelves 414a-d, sales floor 416, fitting room 418, and store entrance 450. Each fixture may also have dimensions corresponding to that fixture within retail environment 410 and may be displayed at scale. If desired, the space on and/or around the fixtures can be divided into adjacent sub-volumes containing different RFID tags for more granular activity tracking as described below.

Typically, the process 300 begins when an LCN detects a person entering the retail environment 410 (302). (The process can also start whenever and wherever an LCN first detects a person in the store.) The LCNs and CV hub track the person walking around the store (340) and interacting with items and fixtures. As part of this tracking, the LCNs and/or CV hub model the people in the retail environment 410 as wireframes and estimate their poses using the wireframes. If desired, the CV hub can assign each person a unique identifier and virtual shopping cart for tracking that person and their interactions with fixtures and objects throughout the store.

FIG. 4B illustrates two people who have been identified in retail environment 410 and are modeled as wireframes. Wireframes of first person 444 and second person 446 may be generated based on 2D images captured by the LCNs. Poses of first person 444 and second person 446 may be estimated by aggregating pose estimates from each LCN that detects the respective person and identifies them in the image data. The LCNs identify and locate joints (e.g., wrists, elbows, shoulders, fingers, etc.) using keypoint detection, e.g., by projecting 2D joint keypoints onto a 3D joint keypoint. These aggregated pose estimates are then smoothed and averaged to reduce noise and improve accuracy. Additionally or alternatively, viewing angles for respective LCNs may be accounted for by taking a weighted averaging of the 2D joint keypoint detections. Further, one or more heuristics or constraints may be applied to the and pose estimation, such as the detected person must be upright.

LCNs also detect when a person enters an area within arm's reach of a fixture (310) and monitor the person's interactions with items on or in different sub-volumes above and/or around the fixture as shown, for example, in FIG. 4C. The fixtures in FIG. 4C include back of house (boho) fixture 462, office table 464, rack 466, table 468, center table 472, and free-standing rack 474. The sub-volumes associated with the fixtures may be denoted by one or more coordinates, which may be relative to a global coordinate system, or may be root relative. Sub-volumes may be uniform in size or may vary from fixture to fixture or within a single fixture. As an example, each sub-volume may be about 1 ft by 1 ft by 1 ft in size and be denoted by a coordinate in a corner of the sub-volume. FIG. 4C illustrates root relative sub-volumes for each fixture in retail environment 410. For example, boho fixture 462 is depicted as being 1 ft deep by 3 ft tall by 3 ft long. Boho fixture 462 is depicted as containing or otherwise being associated with nine sub-volumes.

An LCN detects an interaction between a person and a fixture by determining an intersection of a wrist joint, hand, or other 3D keypoint of a wireframe of the person with a sub-volume associated with the fixture. The wrist joint may be modeled as a 3D Gaussian distribution representing a probability that the wrist joint is at a particular location at a given time (in order to account for LCN resolution limitations). The LCN tracks intersections of this 3D Gaussian distribution with each individual fixture sub-volumes over time. This intersection probability may be smoothed over time using an exponential moving average. The intersection probability may then be used to feed a binary classifier that determines whether a person's wrist has interacted with a given sub-volume at a given time t. For example, the binary classifier may determine that a person's wrist has interacted with a given sub-volume based on a location probability, as indicated by the 3D Gaussian wrist position distribution, exceeding a threshold.

As explained above with respect to FIG. 2A, the action recognition ML model may classify actions or events into one of four categories: reach in (312), reach out (314), pickup item (316), or drop item (318). The reach in action may include a wrist, elbow, or other joint keypoint moving into the sub-volume from outside the sub-volume. The reach out action may include a wrist, elbow, or other joint keypoint in the sub-volume moving out of the sub-volume (after a reach in action is detected). The pick up item action corresponds to the person picking up an item within the sub-volume. A drop item action corresponds to the person dropping or leaving an item in the sub-volume. These events can occur in many different sequences, including: (1) reaching in and reaching out; (2) reaching in, picking up an item, and reaching out (with the item); (3) reaching in (with an item), dropping the item, and reaching out (without the item); (4) reaching in, picking up an item, dropping the item, and reaching out; and so on. If the LCN misses one action in the sequence, it may skip directly to the observed state—if it detects a wrist or hand in a sub-volume, for instance, without detecting or identifying a reach in action, it may skip directly to the next observed action or event, i.e., pickup item, drop item, or reach out.

The action recognition ML model (block 232 in FIG. 2A) may also assess person track locations within a threshold distance of the fixture. Person track locations outside of the threshold distance (e.g., 0.5 meters, 1 meter, 3 meters, etc.) may be removed from consideration since it would be physically impossible for a person to reach a fixture from the threshold distance or beyond. The closest person track location to the fixture (which is also within a physically reasonable distance of the fixture) may be identified as associated with the person who interacted with the fixture and/or one, some, or all of the objects disposed on the fixture.

In response to detecting a pickup item or drop item action, the LCN and/or CV hub triggers the RFID controller and nearby RFID sensor(s) to query the RFID tags in the corresponding sub-volume (360) as explained in greater detail below. The RFID sensor determines which RFID tags are moving (because they have been picked up or moved) or have stopped moving (because they have been dropped) based on the RFID tags' responses to the query. The RFID controller and RFID sensor(s) track the moving RFID tag(s) and match their movement(s) to the movement of a person detected by the LCN(s) and/or CV hub. If an RFID tag's movement correlates with a person's movement, providing a person-product association, then the system adds the corresponding item to the person's virtual shopping cart (322). Similarly, if an RFID tag's movement stops correlating with a person's movement, then the system removes the corresponding item from the person's virtual shopping cart (322).

Once a pickup event has been confirmed, the LCNs continue to track the corresponding person walking around the store (340), but with one or more items attributed to their person (e.g., in a “virtual cart”). As the person continues to move through retail environment 410, their path may be extrapolated and/or predicted for a predetermined amount of time (e.g., the next 2 seconds, 3 seconds, 5 seconds, or the like). RFID controller may utilize this extrapolated path to schedule interrogation of the RFID tags the person is (likely to be) carrying in a volume the person is likely to occupy in the next couple of seconds. This may enable a targeted, efficient use of RFID sensors to more quickly and repeatedly query a small number of RFID tags (instead of querying all RFID tags in a general area and identifying those that have moved). If any discrepancies arise between RFID tags appearing in the predicted volume and RFID tags predicted to appear in that volume, RFID controller may revert to a prior state representing locations of RFID tags in retail environment 410 and any that are associated with the tracked person and test other high-likelihood tags for association with the person to refine predictions for RFID tag attribution and inventory management.

When an LCN detects a drop event, RFID controller may cause the RFID sensor(s) to interrogate a dropped location for the RFID tags affixed to items in the corresponding virtual shopping cart immediately before the drop event after the person has moved a threshold distance away from the drop location. RFID controller may therefore determine which items formerly associated (and moving) with the person are now at the drop location, which can be used to update the person's “virtual cart.” RFID controller may further cause one or more RFID sensors to periodically interrogate the person's location using SELECT queries of the items associated with them prior to the drop event to confirm which item is systematically missing. This enables system 100 to determine which items are dropped off or abandoned with a higher degree of certainty.

The LCN(s) detect when a person exits the zone or area near a fixture after reaching out of the sub-volume(s) associated with that fixture (320). The LCNs track the person as they walk around the store (340) and either go to the same or another fixture (310), exit the store (342), or enter the cashwrap area (322). In response to detecting a person entering the cashwrap area, the system checks for whether or not the person dropped any items (324) while in the retail environment 410. If the person did drop an item, the system determines the item's location by querying the RFID tag affixed to the item with one or more RFID sensors. If desired, the system can use the person's track through the store as derived from the image data collected by the LCN(s) to determine which section(s) of the store to query for dropped items. If the person dropped the item where the person picked it up in the first place (350) or at the cashwrap or fitting room (352), the system marks the item as abandoned, e.g., for future analysis of item popularity and/or customer shopping habits. If the system detects the item elsewhere, it marks the item as misplaced (356) and may signal the item's current location to a sales associate via an interface on a smartphone, tablet, or computer along with an indication that the item should be returned to its proper location. The system may also determine whether an item has been abandoned or misplaced in response to detecting a drop event during a fixture interaction.

Once the person has finished purchasing their item(s) and an LCN detects them exiting the cashwrap (326), the system updates their virtual shopping cart to reflect their purchase(s) 328. The LCNs continue to track the person walking around the store (340) until eventually detecting the person leaving the store (342). At this point, the system checks the person's virtual shopping cart for items that have not been purchased (344). If all the items in the person's virtual shopping cart have been purchased, the person exits the store normally (346); otherwise, the system flags that items that have not been purchased as potentially stolen (348) and may trigger an alarm and/or send a notification to a sales associate, store manager, or security personnel via a smartphone, tablet, or computer communicatively coupled to the system.

### Querying RFID Tags in Response to Fixture Interaction Events

The RFID sensors can use one or more of several techniques to locate RFID tags in response to pick up and drop item events, including techniques based on angle-of-arrival (AOA) measurements and channel estimates. AOA-based location techniques involve measuring the AOA of a tag's reply at an RFID sensor's antenna. The system can use multiple RFID sensors to measure AOAs of responses from the same RFID tag, then triangulate the RFID tag's location from the AOAs. Alternatively, the system can estimate the RFID tag's location based on a single AOA measurement and either an assumption or measurement of the tag's height above the floor or distance from the ceiling. The system can make and average AOA measurements when the store is closed, e.g., at night, to generate precise estimates of the locations of the RFID tags in the store. RFID tags generally do not move unless moved by a person, so determining the tag locations when nobody is in the store yields very accurate tag location estimates (e.g., to within 12 inches, 8 inches, 6 inches, 3 inches, 1 inch, 0.5 inches, etc.).

The system uses channel estimates to estimate RFID tag locations when people are moving throughout the store, e.g., when the store is open. Channel estimates represent the physical communication channels between the RFID sensors and RFID tags. A change in a channel estimate typically indicates that the communications channel between an RFID sensor and an RFID tag's has changed, e.g., because the RFID tag and/or something in its surroundings has moved. The RFID sensors and RFID controller can measure channel estimates quickly and so them to determine if a tag is moving or has moved after a fixture interaction.

More specifically, each channel estimate represents the combined effects, at a particular carrier frequency, of multipath, scattering, fading, power decay with distance, etc., between the RFID tag and RFID sensor that define the endpoints of the corresponding communications channel as well as the antenna responses of that RFID tag and RFID sensor. (Noise, sensor calibration errors, and other imperfections (e.g., channel estimation errors) can also affect the decoding of the replies but tend not to degrade the communications channels themselves.) Each channel estimate can also account for distortion, filtering, amplification, attenuation, and other effects caused by components in the communications channel, including filters, amplifiers, analog-to-digital converters (ADCs), antennas, and so on in the RFID sensor. The channel estimates can also vary with transmission parameters of the interrogation signals and the sensors' antenna arrays, including originating sensor, carrier frequency, and beamforming sector, and so can be indexed or stored in a lookup table (LUT) according to these parameters.

Because the RFID sensors and RFID tags occupy different positions, each communications channel is unique. The uniqueness of each communications channel comes from the relative angles at which the signal hits the different elements of the receiving antenna array in the RFID sensor. If a tag moves, then the communications channels—and hence the respective channel estimates—between that tag and the sensors change. Unless the retail environment changes, however, the channel estimate between a given pair of locations for a given set of parameters (e.g., sensor, beamforming sector, signal/reply carrier frequency, and tag orientation relative to the sensor) should not change. This means that the channel estimate for a communications channel between a fixed sensor and a tag at a given location, parameterized by RFID tag type, beamforming sector, and signal/reply carrier frequency, should remain valid for the tag's location and orientation even if the tag is moved. Since the sensors are fixed, the channel estimate for a particular sensor, operating at a particular carrier frequency and beamforming sector, can be mapped to the location and orientation of a particular tag, which can be determined from AOA measurements by the RFID sensors when the store is closed, image data acquired by an LCN, or other sources, including a priori knowledge. Thanks to the tag location estimates and channel estimates collected by the RFID sensors, the RFID sensors and/or RFID controller can store a list of tags associated with each sub-volume in the store.

As a person approaches a fixture, the channel estimates for RFID tags on the fixture may become noisy or change with respect to their nominal values. When an LCN detects a fixture interaction event, such as a pickup or drop item event, in a particular sub-volume, it can prompt a nearby RFID sensor to query and determine current channel estimates for the RFID tags in that sub-volume. The RFID sensor compares these channel estimates against the most recent channel estimates for the same tags. For each RFID tag, if the current channel estimate is close enough (e.g., within a threshold distance in channel estimate space) to the most recent channel estimate, then the sensor estimates the RFID tag's location to be the same as it was before. If that RFID tag's current channel estimate is not close enough to the most recent channel estimate (e.g., farther than the threshold distance), then the sensor estimates that the RFID tag is moving or has moved (e.g., has been picked up by the person reaching into the sub-volume).

In some cases, the RFID sensors may query and determine channel estimates for RFID tags in the store on a periodic basis (e.g., once every fraction of a second, every second, or every few seconds). In these cases, detection of the fixture interaction event prompts the RFID sensor and/or RFID controller to review the most recently collected channel estimates for the RFID tags in the corresponding sub-volume for changes indicating RFID tag movement. Detecting a person leaving a fitting room or cashwrap region may also trigger a review of recently collected channel estimates in the fitting room or cashwrap region as appropriate.

More specifically, the RFID controller and/or RFID sensor(s) may execute a ML model trained to analyze tag behavior (changes in channel estimates). This ML model uses the positions of the RFID tags in the affected sub-volume (e.g., estimated from AOA measurements), the distance between the current and historic or previously measured channel estimates for each RFID tag/sensor pair, and the location of the person track for the person interacting with the sub-volume. The RFID sensors measure the locations and channel estimates of RFID tags in the store or area periodically, e.g., every second or every few seconds, to provide baseline information about the RFID tags, their locations, and the corresponding channel estimates for the ML model to use in analyzing tag behavior.

When an LCN detects a fixture interaction event between a person and a particular sub-volume, the ML model can use previously obtained RFID tag responses to analyze the RFID tag over two time windows before the fixture interaction event: (1) a first time window 5-10 seconds before the fixture interaction event; and (2) a second time window 0-5 seconds before the fixture interaction event. The ML model is trained to analyze channel estimates derived from RFID tag signals over these time windows to classify RFID tags as either moving or stationary. The ML model may recognize fluctuations, or noise, in the differences between the current and historic channel estimates during the first time window (e.g., 5-10 seconds) before the fixture interaction event as an indication that a person is approaching or close to the sub-volume containing the RFID tags.

Data collected during these two time windows can be used to train the ML to detect RFID tag motion events. More specifically, these data can be used to generate aggregated model features for training the ML model, including: tag displacement and velocity within the time window; distance of the tag to known points, such as the cashwrap or fitting room; the rate of change of the tag's channel estimate; the difference between the tag's channel estimate and a reference channel estimate at the cashwrap, fitting room, etc.; and the distance from the nearest person to the tag's assigned fixture (home zone). Training the ML model on multiple time windows allows the ML model to learn from changes in feature values over time. Using training data collected over more time windows is also possible but increases the complexity and the number of model features. The time windows can also be shorter or longer, depending on how frequently the sensors read the RFID tags.

(Alternatively, the ML model can be trained to recognize very large changes in channel estimates, i.e., changes that are several times the changes caused by noise in a communications channel between an RFID tag reader and a static RFID tag.)

Generally, as the person reaches into the sub-volume during the first time window, the channel estimates of some or all of the tags in the sub-volume may change. As the person picks up an item with an RFID tag reaches out of the sub-volume with the item and RFID tag during the second time window, the channel estimate for the RFID tag picked up by the person continues to change, and the other channel estimates stop changing. The ML model is trained to classify the RFID tag as moving if its channel estimate changes during the second time window. The system changes the RFID tag's state from stationary to moving, adds the corresponding product to the person's virtual shopping cart, and provides a new product-person association for the corresponding product.

The ML model is also trained to classify a tag that has stopped moving at a fixture sub-volume as attached to a product dropped at that fixture sub-volume by the person and to change the RFID tag's state from moving to stationary. When an RFID tag transitions from a moving state to a stationary state, the RFID controller matches the tag's channel estimate to the average normalized channel estimate for each fixture or zone (cashwrap, fitting room, etc) to figure out where the tag was dropped or abandoned. This provides a new product-fixture association for the corresponding product and makes it easier to find the (abandoned or misplaced) product.

When a person interacts with a sub-volume, RFID controller may determine a probability of each RFID tag within the sub-volume being picked up based on the position of that person's wrist joint in the sub-volume. An LCN 130 may model a wrist joint as a probability sphere, and a probability of a person interacting with an item associated with an RFID tag may correspond to what portion of the probability sphere intersects the sub-volume. Because the system can estimate the position of the wrist joint to within inches of its actual position, this probability distribution falls off sharply outside of the person's reach, leaving a small number (e.g., less than 5, less than 3, only 1, etc.) of RFID tags that are likely to be picked up. Because the RFID sensors and/or RFID controller have records of the RFID tags in the sub-volume and their locations, they can query only those RFID tags with a significant probability (e.g., greater than 25%, 50%, or 75%) of being picked up. Limiting the number of RFID tags being queried based on the RFID tags' probabilities of being picked up greatly reduces the total query time and enables a higher tag revisit rate by the RFID sensors.

RFID controller may also use universal product code (UPC) masking to target specific RFID tags that have a higher probability of being picked up, or which have been picked up. For example, the UPC masking can be based on the styles, colors, classes (e.g., t-shirts, pants, etc.), and/or sizes of products that are frequently placed together. UPC masking may allow for a high-frequency stream of channel estimates for the reduced number of RFID tags, which may then be passed into a tag motion classification model and stateful attribution model.

### RFID Sensor Architecture

FIG. 5A illustrates the RFID sensor 120 in greater detail. Unlike other RFID sensors, this RFID sensor 120 can optionally be configured to switch between an interrogator mode in which it transmits signals to tags and receives their responses and a listener mode in which it receives signals from other sensors and from tags but does not transmit signals itself. Using multiple sensors switchable between interrogator and listener modes together circumvents range limits imposed by self-interference, noise, and FCC limits on transmission power and reduces the time it takes to detect and locate tags. For more on interrogator and listener modes, see, e.g., U.S. Pre-Grant Publication No. 2024/0193381 A1, entitled “RFID Tag Readers Switchable Between Interrogator and Listener Modes,” which is incorporated herein by reference in its entirety for all purposes.

The sensor 120 includes an RF antenna array and front end 556, a processor 552, an RF calibration and tuning block 554, a hop generator 560, and a hop receiver 570. The RF antenna array and front end 556 may include one or more antenna elements (e.g., arranged in a multi-element antenna array), amplifiers, filters, and/or other analog RF components for transmitting RFID interrogation signals 551 and receiving tag replies 553 and, optionally, RFID interrogation signals from other sensors. The processor 552 may be implemented in a microcontroller, application-specific integrated circuit (ASIC), field-programmable gate array (FPGA), or other suitable device and controls the operation of the sensor 120, including, if desired, steering of the sensor's antenna array. It stores information in and retrieves information from a memory (not shown), which may store lookup tables (LUTs) as described below, and communicates with the appliance 160 via a network connection (not shown), such as an Ethernet connection. If the sensor 120 is configured to operate in interrogator and listener modes, the processor 552 switches the sensor 120 between interrogator and listener modes, with the hop generator 560 being disabled or off in listener mode and enabled or on in interrogator mode and the hop receiver 570 being enabled or on in both modes. The RF calibration and tuning block 554 performs RF calibration and tuning functions.

In interrogator mode (but not listener mode), the hop generator 560 generates the interrogation signals 551 that the sensor 120 transmits to the RFID tags 142. The hop generator 560 can optionally also generate commands or communications signals intended for other sensors 120, e.g., on a dedicated sensor communications channel or with particular preambles or payloads. It includes a digital command generator 562, which generates the digital queries, commands, and/or other information conveyed by the interrogation signals 551, and RF electronics 564 for turning the digital signals from the command generator 562 into analog signals suitable for transmission by the antenna array in the front end 556. The RF electronics 564 may include a digital-to-analog converter (DAC) that converts the digital signal into a baseband analog signal, a mixer and local oscillator to mix the baseband analog signal up to an intermediate frequency for broadcast, and filters and/or pulse shapers to remove sidebands and/or spurs.

The hop receiver 570 includes a receiver front end 572 coupled to a command demodulator 574 and a tag reply demodulator 576. Generally, the receiver front end 572 digitizes, downconverts, and estimates the phase of the RF signals detected by the antenna(s). There are a variety of ways to configure the receiver front end 572; in this example, it receives analog in-phase and quadrature (I/Q) signals at higher frequency (e.g., 40 MHz) and converts them into digital I/Q samples at baseband (e.g., 5 MHz).

A hop receiver 570 may perform averaging of tens or hundreds of commands and/or replies received by the hop receiver 570 to further improve clock synchronization accuracy. For example, a sensor 120 may receive 100 replies during a hop, each reply being assigned a timestamp associated with a time of arrival of the reply. Hop receiver 570 may calculate an average across the times of arrival for each of the 100 replies received during a hop to remove noise and determine at what time a command was likely to have been sent according to a clock of sensor 120. This time may then be compared with a time indicated by clocks of one or more other sensors to determine if further clock disciplining is warranted. Additionally or alternatively, hop receiver 570 may compare timestamps of the first received signal and the last received signal to determine clock drift between sensors.

In interrogator mode, the front end 572 also cancels any self-interference caused by the interrogation signals 551, for example, due to leakage within the receiver. Fortunately, the receiver front end 572 can generally cancel crosstalk between different antenna elements and the circuits coupled to those antenna elements because the crosstalk is correlated with the interrogation signal 551. This crosstalk can be further reduced or suppressed by spacing the antenna elements farther apart from each other as explained in U.S. Pre-Grant Publication No. 2024/0330619 A1, entitled “Antenna Arrays and Signal Processing for RFID Tag Readers,” which is incorporated herein by reference in its entirety for all purposes.

When the sensor 120 is in listener mode, it does not transmit an interrogation signal, nor does it perform self-interference cancellation. In listener mode, the sensor 120 detects the channels on which the other sensors 120 transmit interrogation signals 551 and estimates the frequencies of those other interrogation signals 551.

The command demodulator 574 is enabled when the sensor 120 is in listener mode and demodulates commands from other sensors to reproduce the interrogator's signals at the command bit rate (e.g., 40 kbps to 560 kbps). The command demodulator 574 uses the command payload to determine what the sensor in interrogator mode is asking of the tag 530 (e.g., modulation, preamble type, expected reply type, etc.). For example, the sensor 120 in interrogator mode may ask the tag 530 to send the first 64 bits of its EPC using Miller-2 modulation at 320 kHz backscatter link frequency (BLF) with the standard preamble. The sensors 120 in listener mode use that information to decode the tag reply 553. The command demodulator 574 is disabled when the sensor 520 is in interrogator mode.

The tag reply demodulator 576 is enabled in both interrogator and listener modes and demodulates the baseband tag reply I/Q samples to produce tag reply signals at the tag reply bit rate.

### RFID Controller Architecture

FIG. 5B shows an RFID controller 160 (also called an interrogator controller or appliance) in greater detail. The appliance 160 can include one or more processors, non-volatile memories, and other logic devices implemented as integrated circuits and powered by appropriate power supplies and other housekeeping electronics. These processors and logic devices may include discrete components that perform discrete functions and/or more general-purpose components that are programmed to perform a variety of functions, either by themselves or in concert with other components of the RFID controller 160. For instance, the RFID controller 160 may include a central processor unit (CPU) 542 running an operating system (e.g., Alpine Linux OS) that manages the controller appliance's hardware and software resources, including communications interfaces, shown as Ethernet connections Eth0 and Eth1, connected to the sensors 120, the POS system, and/or other devices. The controller appliance's non-volatile memory can store the operating system and other firmware and software as well as tag state information.

FIG. 5B illustrates the RFID controller 160 as a block diagram, where each block represents a different function or sub-function performed by the RFID controller 160 using its processor(s) and memory. To monitor and update tag states, the RFID controller 160 includes or implements an in-store message router 580, RFID interrogator controller (RFID-IC) 582, location state manager 584, tag state manager 586, and retail backend application programming interface (API) 588. The in-store message router 580 queues and routes messages exchanged between the sensors 120 and RFID-IC 582 via the Ethernet connections Eth0 and Eth1. The RFID-IC 582 employs a split media access controller (MAC) design to handle messages exchanged with the sensors 120, with a lower MAC layer implemented in the sensors 120 and an upper MAC layer implemented in the RFID-IC 582. The lower MAC layer determines a timestamp and parameters, estimated from the RFID tag's backscattered response, useful for determining the tag's position. The upper MAC layer schedules hop transmissions and the general purpose of each hop. The lower MAC layer executes more time-critical functions, such as actually scheduling when to transmit commands and how to react to replies within a hop. A positioning layer comprising the RFID-IC and/or the sensor(s) 120 calculates the RFID tag's position in a 3D coordinate system (e.g., Cartesian coordinates with an origin at a known location in the store or room) from data coming from the MAC and PHY layers. The messages from the sensor 120 may also include data read from the RFID tag, including the RFID tag's EPC and other metadata.

The location state manager 584 and tag state manager 582 track the RFID tag's location and state, respectively. The location state manager 584 receives the RFID tag's estimated location from the RFID-IC 582 (e.g., in a Cartesian coordinate frame with the origin at one corner of the store) and determines where (e.g., the room and zone) in the RFID environment in which the RFID tag is located. The rooms and zones may be extracted from a 3D model of the store or space. In a retail RFID environment, the rooms and zones can include a receiving area, stockroom, sales floor, and changing room, with the sales floor further divided into an entrance/exit zone and a checkout zone. The location state manager 584 updates each RFID tag's location in an inventory database 590, which may be hosted locally or off site (e.g., in the cloud), based on changes in location detected by the sensor(s) 120.

The tag state manager 586 manages the tag's state, including its location and availability. There are several possible availability states, including but not limited to: (1) available; (2) stale (optional); (3) ignored; (4) missing; and/or (5) sold. There may be other states as well. The tag state manager 586 transitions the RFID tags 142 among these states based on the tags' responses (or lack of responses) to queries from the sensors 120, including information about the tags' locations, and on the tag states stored in the inventory database 590. For more on tag states and stateful inventory management, please see U.S. Pre-Grant Publication No. 2024/0386375 A1, entitled “Stateful Inventory for Monitoring RFID Tags,” which is incorporated herein by reference in its entirety.

The tag state manager 586 updates the tag states stored in the inventory database 590 and forwards both the tag state and tag location estimate to the retail backend lite API 588, which implements the backend functions for inventory, restocking, and product lookup. The retail backend lite API 588 can implement these functions via a web app gateway 594, which implements a Hypertext Transfer Protocol (HTTP) proxy, redirecting Representational State Transfer (REST) requests to the appropriate backend server (not shown). The web app gateway 594 can also provide user authentication and authorization and serves the static files used by browsers to render web pages.

FIG. 5B also shows several optional components of the RFID controller 160, including a raw tag server 592, space server 593, Trivial File Transfer Protocol (TFTP) server 595, multicast Domain Name Service (mDNS) server 596, Network Time Protocol (NTP) server 597, Secure Shell (SSH) server 598, and Secure Sockets Layer (SSL) certificate store 599. The space server 593 handles firmware lifecycle management and configuration of the sensors 120 and Power-over-Ethernet (PoE++) switches (not shown) that connect the RFID controller 160 to the sensors 120. The raw tag server 592 retrieves tag metadata for legacy APIs, such as those used by API clients for system debugging. When they boot, the sensors 120 download executable images from the TFTP Server 595. The mDNS server 596 enables the RFID controller 160 to advertise itself using the mDNS and DNS-SD protocols, e.g., for during debugging. The NTP server 597 connects and synchronizes with a remote (e.g., Internet-based) NTP server and provides NTP service to the sensors 120. The SSH server 598 is also used for debugging. And the SSL certificate store 599 hosts the server certificates used by the sensors 120 and the web-server certificate used by the REST clients to authenticate the RFID controller 160.

### Local Camera Node (LCN) Architecture

FIG. 6 illustrates an LCN 130 in accordance with the present technology. LCN 130 may include a housing 610 and lens 612. Electromagnetic waves including visible light, infrared light, ultraviolet light, etc., may pass through lens 612 and be focused onto an image sensor 620. LCN 130 further includes an image signal processor (ISP) 630, which is communicatively coupled to the image sensor 620 and configured to process raw data from the image sensor 620 and convert it to an image format interpretable to humans, software, or the like. ISP 630 may be communicatively coupled to one or more of a central processing unit (CPU) 640, graphics processing unit (GPU) 650, and/or neural processing unit (NPU) 660. ISP 630 may transmit processed image data to one or more of CPU 640, GPU 650, and/or NPU 660 for further processing, such as person tracking, object identification, pose estimation, triangulation, or other suitable functions. LCN 130 may include power and network communications connections, which may take the form of a PoE connection 614. PoE connection 614 is connected to LCN 130 through network interface 616 and may provide a data transfer interface for communicating with a CV hub. PoE connection 614 may further provide electrical power for LCN 130.

CPU 640 may include memory such as flash memory, short-term storage, long-term storage, or the like. CPU 640 may perform processes such as data transfer management, task assignment, power and voltage regulation, or other suitable tasks. LCN 130 may optionally include GPU 650, which may be configured to process one or more images captured by image sensor 620 and/or processed by ISP 630. LCN 130 may further included NPU 660, which may be configured to perform high-efficiency and fast calculations of neural networks or other AI image processing models, for example, to enable object recognition, pose estimation (including calculating probability distributions associated with wrist joints and other elements of a 3D wireframe or similar representation of a person or tracked object), state attribution, action recognition, fixture interaction event detection, path prediction, or any suitable functionality.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of tracking objects and people in a retail environment, the method comprising:
acquiring, with a camera, imagery of a person in the retail environment;
estimating a pose of the person based on the imagery;
determining, based on the imagery and the pose of the person, that the person has inserted a hand into a predefined volume within the retail environment;
in response to determining that the person has inserted the hand into the predefined volume, transmitting, by a radio-frequency identification (RFID) tag reader, a signal to an RFID tag affixed to an object in the predefined volume;
receiving, by the RFID tag reader, a response from the RFID tag to the signal; and
determining, based on the response from the RFID tag, that the person moved the object.

2. The method of claim 1, wherein determining that the person has inserted the hand into the predefined volume comprises determining a location of a joint keypoint of the pose relative to the predefined volume.

3. The method of claim 1, wherein determining that the person has moved the object comprises determining, based on the response from the RFID tag to the signal, a change in a channel estimate representing a communications channel between the RFID tag reader and the RFID tag.

4. The method of claim 3, further comprising, before determining that the person has inserted the hand into the predefined volume:
measuring, with the RFID tag reader, a baseline channel estimate representing the communications channel between the RFID tag reader and the RFID tag,
wherein determining the change in the channel estimate is based at least in part on the baseline channel estimate.

5. The method of claim 1, further comprising:
tracking, based on the imagery, the person through the retail environment to the predefined volume.

6. The method of claim 1, further comprising:
determining that the person has picked up the object and the RFID tag based at least in part on the response from the RFID tag.

7. The method of claim 1, further comprising:
determining that the person has withdrawn the object and the RFID tag from the predefined volume based at least in part on the response from the RFID tag; and
associating the object with the person in response to determining that the person has withdrawn the object and the RFID tag from the predefined volume.

8. The method of claim 1, further comprising:
determining that the person has dropped the object and the RFID tag based at least in part on the response from the RFID tag.

9. A system for tracking objects and people in a retail environment, the system comprising:
a camera to acquire imagery of a person in the retail environment;
at least one processor, operably coupled to the camera, to estimate a pose of the person based on the imagery and to determine, based on the imagery and the pose of the person, that the person has inserted a hand into a predefined volume within the retail environment; and
a radio-frequency identification (RFID) tag reader, operably coupled to the at least one processor, to transmit a signal to an RFID tag affixed to an object in the predefined volume in response to the person inserting the hand into the predefined volume and to receive a response from the RFID tag to the signal,
wherein the at least one processor is configured to determine, based on the response from the RFID tag, that the person moved the object.

10. The system of claim 9, wherein the at least one processor is configured to determine that the person has inserted the hand into the predefined volume by determining a location of a joint keypoint of the pose relative to the predefined volume.

11. The system of claim 9, wherein the at least one processor is configured to determine that the person has moved the object by determining, based on the response from the RFID tag to the signal, a change in a channel estimate representing a communications channel between the RFID tag reader and the RFID tag.

12. The system of claim 11, wherein the RFID tag reader is further configured to measure a baseline channel estimate representing the communications channel between the RFID tag reader and the RFID tag before the person has inserted the hand into the predefined volume.

13. The system of claim 9, wherein the at least one processor is further configured to track, based on the imagery, the person through the retail environment to the predefined volume.

14. The system of claim 9, wherein the at least one processor is further configured to determine that the person has picked up the object and the RFID tag based at least in part on the response from the RFID tag.

15. The system of claim 9, wherein the at least one processor is further configured to determine that the person has dropped the object and the RFID tag based at least in part on the response from the RFID tag.

16. A method of tracking an object located within a predefined volume and a radio-frequency identification (RFID) tag affixed to the object, the method comprising:
detecting, with an image sensor, a person inserting a hand into the predefined volume;
in response to detecting the person inserting the hand into the predefined volume, detecting, with an RFID tag reader, a change in a channel estimate representing a communications channel between the RFID tag reader and the RFID tag; and
determining that the person has picked up the object based on the change in the channel estimate.

17. The method of claim 16, wherein detecting the person inserting the hand into the predefined volume comprises estimating a pose of the person from image data of the person acquired by the image sensor.

18. The method of claim 16, wherein detecting a change in the channel estimate comprises:
determining a first channel estimate for the communications channel before the person inserts the hand into the predefined volume;
determining a second channel estimate for the communications channel within a predefined period of the person inserting the hand into the predefined volume; and
comparing the first channel estimate to the second channel estimate.

19. The method of claim 16, further comprising:
associating the object with the person; and
tracking the object and the person using the image sensor and the RFID tag reader.
